(19) United States
(12) Patent Application Publication
(10) Pub. No.: US 2023/0050577 A1
(43) Pub. Date: Feb. 16, 2023

(54) LASER WELDING METHOD AND METHOD FOR MANUFACTURING ELECTRIC ROTATING MACHINE USING SAME

(71) Applicants: DAIKIN INDUSTRIES, LTD., Osaka (JP); OSAKA UNIVERSITY, Osaka (JP)

(72) Inventors: Masatoshi ITOU, Osaka (JP); Takashi NISHIKAWA, Osaka (JP); Masahiro TSUKAMOTO, Osaka (JP); Yuji SATO, Osaka (JP); Tetsuo SUGA, Osaka (JP)

(21) Appl. No.: 17/976,518

(22) Filed: Oct. 28, 2022

Related U.S. Application Data
(63) Continuation of application No. PCT/JP2021/011791, filed on Mar. 22, 2021.

(30) Foreign Application Priority Data
Apr. 30, 2020 (JP) 2020-079962

(51) Int. Cl. B23K 26/244

(52) U.S. Cl. CPC B23K 26/244

(57) ABSTRACT

A laser welding method is usable to weld a material containing copper as a main component. The laser welding method includes heating the material by irradiation with a first laser light and welding the material by irradiation of a portion, which has been irradiated with the first laser light, of the material with a second laser light with which an energy absorption rate of the copper contained in the material increases by an increase in a temperature of the material. A wavelength of the first laser light is 400 nm to 470 nm.

### CROSS-REFERENCE TO RELATED APPLICATIONS

This is a continuation of International Application No. PCT/JP2021/011791 filed on Mar. 22, 2021, which claims priority to Japanese Patent Application No. 2020-079962, filed on Apr. 30, 2020. The entire disclosures of these applications are incorporated by reference herein.

### BACKGROUND

### Technical Field

The present invention relates to a laser welding method and a method for manufacturing an electric rotating machine by the laser welding method.

### Background Art

A welding method using laser light has been widely known. For example, Japanese Unexamined Patent Publication No. 2009-269036 discloses that a workpiece is preheated by irradiation with a first laser light along a planned welding line, and is welded by irradiation of the preheated portion with a second laser light while a filler wire is supplied to the preheated portion.

### SUMMARY

A first aspect of the present disclosure is directed to a laser welding method for welding a material containing copper as a main component. The laser welding method includes heating the material by irradiation with a first laser light and welding the material by irradiation of a portion, which has been irradiated with the first laser light, of the material with a second laser light with which an energy absorption rate of the copper contained in the material increases by an increase in a temperature of the material. A wavelength of the first laser light is 400 nm to 470 nm.

### BRIEF DESCRIPTION OF THE DRAWINGS

FIG. 1 is a sectional view showing a laser welding method according to an embodiment.

FIG. 2 is a graph showing a relationship between the wavelength of laser light at 300 K and the energy absorption rates of various metals including copper.

FIG. 3 is a plan view showing the positions of beams of first and second laser lights (L1, L2).

FIG. 4 is a plan view showing a variation of the positions of beams of the first and second laser lights (L1, L2).

FIG. 5 is a perspective view of an electric rotating machine (30).

FIG. 6 is a perspective view showing a laser welding method for laser-welding end portions of a plurality of conductor segments (32) of the electric rotating machine (30).

FIG. 7 is a perspective view showing the welded end portions of the plurality of conductor segments (32) of the electric rotating machine (30).

FIG. 8 is a perspective view showing a variation of the laser welding method for laser-welding the end portions of the plurality of conductor segments (32) of the electric rotating machine (30).

FIG. 9 is a front view of the welded end portions of the conductor segments (32).

FIG. 10 is a perspective view showing a method for irradiating the end portions of the conductor segments (32) with the first and second laser lights (L1, L2).

FIG. 11 is a perspective view showing a variation of the method for irradiating the end portions of the conductor segments (32) with the first and second laser lights (L1, L2).

### DETAILED DESCRIPTION OF EMBODIMENT(S)

In the following, an embodiment will be described in detail.

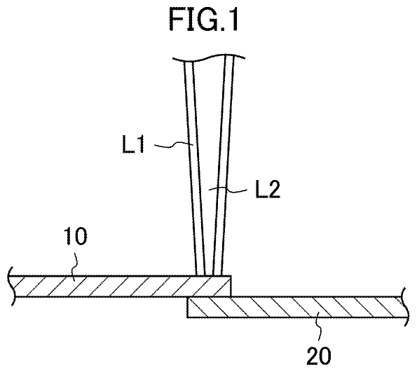

In a laser welding method according to the embodiment, a material (10) containing copper as a main component is irradiated with laser light, and is welded to a bonding target metal material (20). In this case, as shown in FIG. 1, a surface of the material (10) is heated by irradiation with a first laser light (L1), and is welded to the bonding target metal material (20) by irradiation of the heated surface of the portion, which has been irradiated with the first laser light (L1), of the material (10) with a second laser light (L2) with which the energy absorption rate of copper contained in the material (10) increases by an increase in the temperature of the material (10).

In the laser welding method according to this embodiment, the material (10) containing copper as the main component is heated by irradiation with the first laser light (L1). In addition, the portion of the material (10) irradiated with the first laser light (L1) is irradiated with the second laser light (L2). With the second laser light (L2), the energy absorption rate of copper contained in the material (10) increases by an increase in the temperature of the material (10). Thus, when the portion heated and temperature-increased by irradiation with the first laser light (L1) is irradiated with the second laser light (L2), the second laser light (L2) is absorbed by copper contained in the material (10) at a high energy absorption rate, and the high energy density is applied to the material (10). Accordingly, the material (10) is melted, and can be welded to the bonding target metal material (20). Thus, the material (10) containing copper as the main component can be welded to the bonding target metal material (20) by use of a combination of the first and second laser lights (L1, L2).

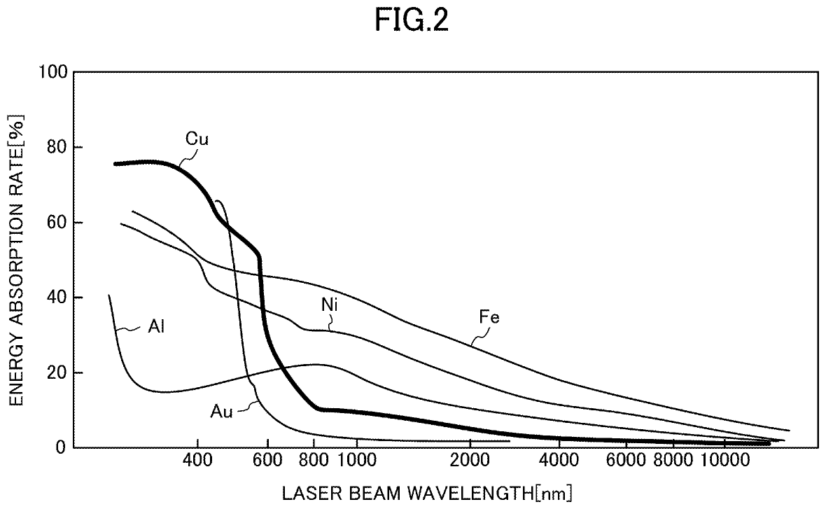

For example, as shown in FIG. 2, for a laser light having a wavelength band of around 500 nm, the energy absorption rate of copper is high, but it is difficult to obtain a level of high energy density which can be used for welding On the other hand, a laser light having a wavelength band of around 1000 nm can provide high energy density suitable for welding, but the energy absorption rate of copper is low for such a laser light. Here, copper has such properties that when the temperature increases, the energy absorption rate for the laser light having a wavelength band of around 1000 nm increases. Accordingly, the former can be suitably used as the first laser light (L1), and the latter can be suitably used as the second laser light (L2).

Here, the material (10) containing copper as the main component may be either pure copper or a copper alloy containing 50 mass % or more of copper. The bonding target metal material (20) may be made of the same metal as in the material (10), which contains copper as a main component, or may be made of a different type of metal.

The wavelength of the first laser light (L1) is preferably 584 nm or less for efficiently increasing the temperature of the material (10), and is more preferably 470 nm, at which the energy absorption rate of copper is high, for stably increasing the temperature of the material (10). The wavelength of the first laser light (L1) is preferably 400 nm or more for a practical perspective. The first laser light (L1) may be a single-wavelength laser light, or may be laser light with a plurality of different wavelengths superimposed.

The energy absorption rate of copper contained in the material (10) for the first laser light (L1) at 300 K is preferably 60% or more, more preferably 80% or more for efficiently increasing the temperature of the material (10).

The power density of the first laser light (L1) is preferably 125000 W/cm² or more, more preferably 500000 W/cm² or more, and preferably 5100000 W/cm² or less for efficiently increasing the temperature of the material (10).

A light source of the first laser light (L1) is preferably a diode laser, more preferably one having an oscillation wavelength band of 400 nm or more to 470 nm or less as described above.

The temperature of the material (10) heated by irradiation with the first laser light (L1) is preferably 200° C. or more, more preferably 400° C. or more, and preferably 1083° C. or less for increasing the energy absorption rate for the second laser light (L2).

The wavelength of the second laser light (L2) is preferably 800 nm or more, more preferably 1030 nm or more, and preferably 1500 nm or less for efficiently bringing the material (10) into a weldable molten state. The wavelength of the second laser light (L2) is preferably 1200 nm or less for a practical perspective The second laser light (L2) may be a single-wavelength laser light, or may be laser light with a plurality of different wavelengths superimposed.

The energy absorption rate of copper contained in the material (10) for the second laser light (L2) after the temperature has increased is preferably 30% or more, more preferably 60% or more for bringing the heated material (10) into the weldable molten state. The energy absorption rate of copper contained in the material (10) for the second laser light (L2) at 300 K before the temperature increases is, for example, 0.9% or more to 8.0% or less.

The power density of the second laser light (L2) is preferably 6250000 W/cm² or more, more preferably 20000000 W/cm² or more, and preferably 200000000 W/cm² or less for efficiently bringing the material (10) into the weldable molten state.

A light source of the second laser light (L2) is preferably an infrared laser.

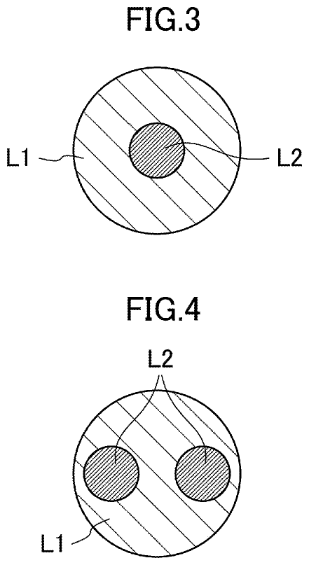

Irradiation of the material (10) with the first and second laser lights (L1, L2) is preferably performed such that the second laser light (L2) is contained in the first laser light (L1), as shown in FIGS. 3 to 5. The number of beams of the second laser light (L2) is one or more for one first laser light (L1), and as shown in FIG. 3, is at least one for one first laser light (L1). However, if there are two or more beams of the second laser light (L2) for one beam of the first laser light (L1) as shown in FIG. 4, the material (10) can be more uniformly melted.

Next, a method of manufacturing an electric rotating machine (30) such as an electric motor or an electric generator by the laser welding method according to the embodiment will be described.

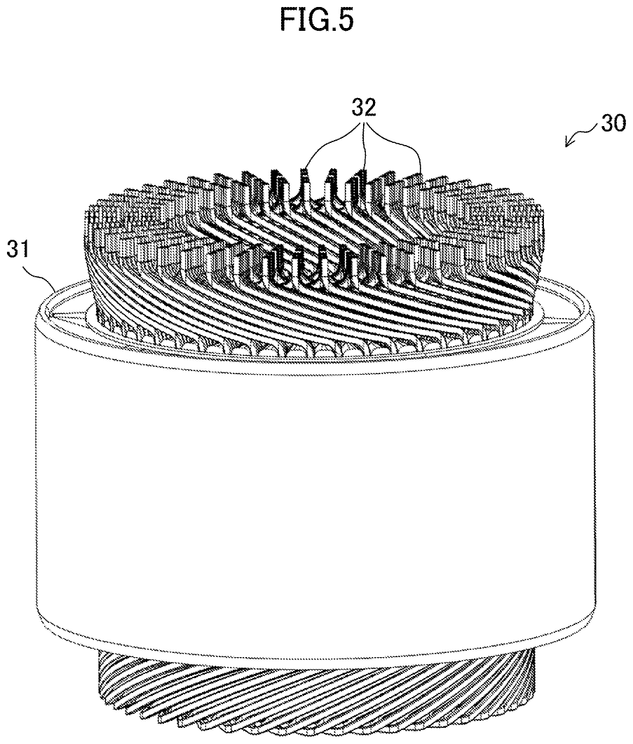

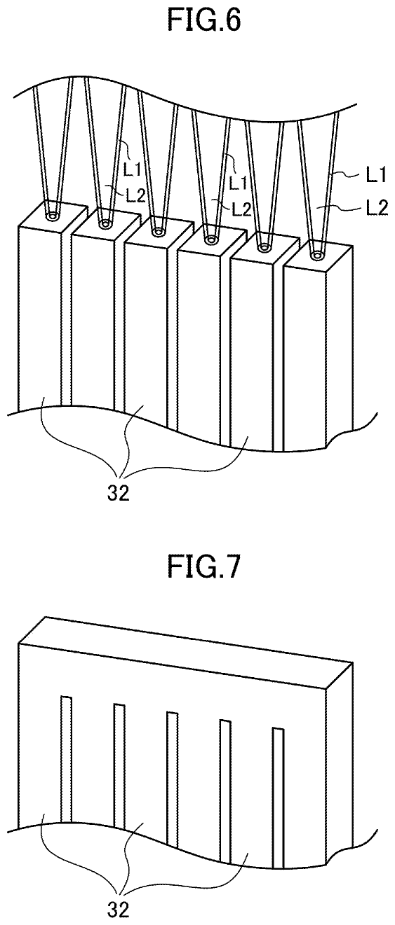

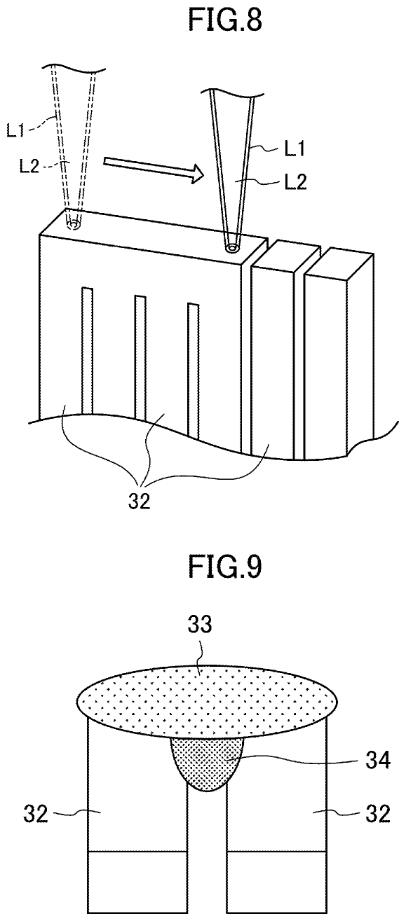

As shown in FIG. 5, in the electric rotating machine (30), a plurality of conductor segments (32) is respectively inserted into a plurality of slots (not shown) formed at a stator core (31), and end portions of the plurality of conductor segments (32) inserted into the slots are made of the material (10) containing copper as the main component. Then, in such manufacturing, each of the end portions of the plurality of conductor segments (32) is spot-irradiated with the first and second laser lights (L1, L2) by the laser welding method according to the embodiment, as shown in FIG. 6. Accordingly, the end portions of the plurality of conductor segments (32) are welded to each other as shown in FIG. 7. In this case, the end portions of the plurality of conductor segments (32) may be irradiated with the first and second laser lights (L1, L2) such that the first and second laser lights (L1, L2) are swept thereon, as shown in FIG. 8.

As described above, the first and second laser lights (L1, L2) are combined using the laser welding method according to the embodiment so that the end portions of the conductor segments (32) made of the material (10) containing copper as the main component can be welded to each other. In this case, since the first laser light (L1) having a low energy density and the second laser light (L2) having a high energy density are superimposed on each other, a thermally-conductive welding portion (33) welded so as to be bridged between end surfaces of the conductor segments (32) and a keyhole-shaped welding portion (34) welded by Infiltration of the material (10) into between the end portions of the conductor segments (32) are formed between the end portions of the conductor segments (32) as shown in FIG. 9. Thus, a high welding strength can be obtained.

Since high energy density is applied to the conductor segment (32), it is not necessary to increase the length of an exposed conductor portion extending to the end portion of the conductor segment (32), and therefore, a coil end portion can be reduced in size. Further, since high-speed welding among the end portions of the conductor segments (32) can be performed, a high production capacity can be obtained. Moreover, since additional equipment for obtaining a high production capacity is not necessary, reduction in an equipment investment can be achieved.

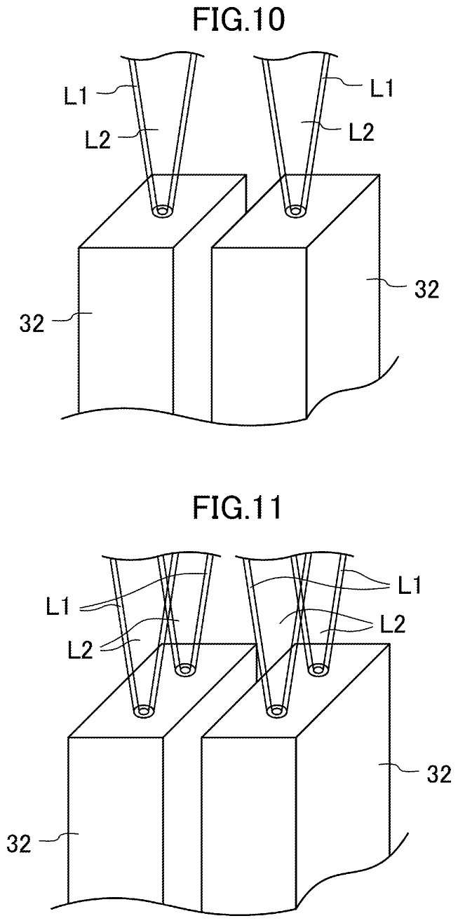

In manufacturing of the electric rotating machine (30), each of the end portions of the plurality of conductor segments (32) is irradiated with one or more pairs of first and second laser lights (L1, L2). Each of the end portions of the plurality of conductor segments (32) is irradiated with at least one pair of first and second laser lights (L1, L2), as shown in FIG. 10. When each end portion is irradiated with two or more pairs of first and second laser lights (L1, L2) as shown in FIG. 11, variation in welding among the end portions of the conductor segments (32) can be reduced.

The present invention is useful for a laser welding method and a technical field using the laser welding method.

1. A laser welding method for welding a material containing copper as a main component, the laser welding method comprising:
heating the material by irradiation with a first laser light and welding the material by irradiation of a portion, which has been irradiated with the first laser light, of the material with a second laser light with which an energy absorption rate of the copper contained in the material increases by an increase in a temperature of the material,
a wavelength of the first laser light being 400 nm to 470 nm.

2. The laser welding method of claim 1, wherein
a light source of the first laser light is a diode laser.

3. The laser welding method of claim 1, wherein
a wavelength of the second laser light is1030 nm to 1200 nm.

4. The laser welding method of claim 1, wherein
a light source of the second laser light is an infrared laser.

5. The laser welding method of claim 1, wherein a number of portions irradiated with the second laser light is two or more for one portion irradiated with the first laser light.

6. The laser welding method of claim 1, wherein
the material is irradiated with two or more pairs of first and second laser lights.

7. A method for manufacturing an electric rotating machine using the laser welding method of claim 1, in which a plurality of conductor segments are respectively inserted into a plurality of slots formed at a stator core and end portions of the plurality of conductor segments inserted into the slots are made of a material containing copper as a main component, the method for manufacturing the electric rotating machine comprising:
welding the end portions of the plurality of conductor segments using the laser welding method.

8. The method for manufacturing the electric rotating machine of claim 7, wherein
each of the end portions of the plurality of conductor segments is irradiated with one or more pairs of first and second laser lights.
